(19) United States
(12) Patent Application Publication
(10) Pub. No.: US 2006/0093878 A1
(43) Pub. Date: May 4, 2006

(54) Fuel cell test station gas-purge system and method

(76) Inventor: Paul Kenneth Adam, Port Moody (CA)

Correspondence Address: BERESKIN AND PARR, 40 KING STREET WEST, BOX 401, TORONTO, ON, M5H 3Y2, CA

(21) Appl. No.: 10/979,193

(22) Filed: Nov. 3, 2004

(51) Int. Cl. H01M 8/00

(52) U.S. Cl. 429/13

(57) ABSTRACT

Abruptly cutting off the power to a fuel cell test station during a trial may, in some instances, be necessary to prevent accidents that may damage equipment and/or harm nearby operators/technicians. Yet, abruptly shutting down a trial may leave the fuel cell test station and fuel cell module under test in a potentially hazardous condition as residual amounts of reactive fuel and oxidant may remain in various parts of the system. It is thus desirable to flush the systems with a purging gas to reduce the possibility of damage caused by residual amounts of fuel and oxidant remaining in the system. However, since the power in such circumstances is cut-off, delivering the purging gas in a reliable way so as to prevent undesired side effects, such as the drying out of the membranes included in some fuel cells, has not previously been achieved. In some embodiments of the invention there is provided a gas-purge system and method, which can be advantageously employed immediately after a loss of power occurs, that controllably delivers a purging gas to a fuel cell test station and fuel cell module under test.

### PRIORITY CLAIM

This application claims the benefit of U.S. Provisional Application No. [Attorney Ref No.: 9351-303], which was filed on Nov. 3, 2003, and the entire contents of which is hereby incorporated by reference.

### FIELD OF THE INVENTION

The invention relates to a fuel cell test station and, in particular to a gas-purge system and method included therein.

### BACKGROUND OF THE INVENTION

Fuel cells convert chemical energy of fuels into electrical energy. In some types of fuel cells hydrogen and an oxidant are used as the basic process reactants in a set of complementary chemical reactions yielding electrical energy as one of a number of reaction products. The development of a fuel cell design requires rigorous testing to ensure that all of the reaction products produced can be predictably regulated during the foreseen operation of the fuel cell.

To that end a fuel cell test station is typically capable of simulating a range of operating conditions for a fuel cell under test and in turn monitoring various parameters indicative of the performance of the fuel cell. Such fuel cell test stations are commercially available from Hydrogenics Corporation in Mississauga, Ontario, Canada, and Greenlight Power Technologies in Burnaby, B.C., Canada.

During the testing process the test station may be suddenly and unexpectedly shutdown for a number of reasons. In such situations power supplied to the test station is cut-off to prevent potential accidents that may damage equipment and/or harm operators/technicians nearby. However, an abrupt loss of operating power does not typically allow the test station to shutdown in a controlled manner, which in turn leaves fuel and oxidant lines leading to and from a fuel cell module under test full of fuel and oxidant, and this may itself be potentially hazardous. Subsequently, it is desirable to actively purge the system with a purging gas such as nitrogen to flush out remaining fuel and oxidant and stop the fuel cell reactions. However, since the power is cut-off abruptly in such circumstances, a reliable system and method for delivering the purging gas in a controllable way has not yet been reliably realized.

### SUMMARY OF THE INVENTION

According to an aspect of an embodiment of the invention there is provided a gas-purge system suited for use in combination with a fuel cell power module including: a process reactant delivery control means for permitting a flow of a process reactant to a fuel cell module when power is supplied to the process reactant delivery control means and stopping the flow of the process reactant when power is cut-off; and, a purging gas delivery control means for delivering a predetermined volume of a purging gas to a fuel cell module in response to the power being cut-off.

In some embodiments the process reactant delivery control means includes a normally closed valve connectable between the fuel cell module under test and a process reactant supply.

In some embodiments the purging gas delivery means has: a first pressure-controlled gate, having a control point, that is operable to open when a suitable pressure is applied to the control point and otherwise to close, and the first pressure-controlled gate is connectable between a purging-gas supply and the fuel cell module under test; a pressure relay connectable between the purging-gas supply and the control point of the first pressure-controlled gate, operable to transfer gas pressure from the purging gas supply to the control point when power is supplied, and subsequently, cut-off the purging gas supply from the control point when the power is cut-off and permit a controlled release of pressure from the control point thereby gradually closing the first pressure-controlled gate after the power is cut-off; and, a normally open valve connectable between the first pressure-controlled gate and the fuel cell module under test.

In some embodiments the first pressure-controlled gate is a dome loaded pressure valve having a diaphragm serving as the control point. In related embodiments, the pressure relay includes a 3/2-way solenoid valve, having a venting port, which is operable to open a flow path between the purging gas supply and the control point of the first pressure-controlled gate when power is supplied and cut-off the purging gas supply from the control point when the power is cut-off.

According to aspects of another embodiment of the invention there is provided a gas-purge system for controllably delivering a purging gas to a fuel cell module and flushing supply and exhaust lines with the purging gas after power to the gas-system has been cut-off, the gas-purge system having: a normally closed valve connectable between at least one process reactant supply and the fuel cell module; a normally open valves connected between at least one purging-gas supply and the fuel cell module; a first pressure-controlled gate, having a control point, that is operable to open when a suitable pressure is applied to the control point and otherwise to close, and the first pressure-controlled gate is connectable between the at least one purging-gas supply and the fuel cell module; and, a pressure relay connectable between the at least one purging-gas supply and the control point of the first pressure-controlled gate, operable to transfer gas pressure from the purging gas supply to the control point when power is supplied, and subsequently, cut-off the purging gas supply from the control point when the power is cut-off and permit a controlled release of pressure from the control point thereby gradually closing the first pressure-controlled gate after the power is cut-off.

According to aspects of yet another embodiment of the invention there is provided a gas-purge system suited for use in combination with a fuel cell power module including: a process reactant delivery control means for permitting a flow of a process reactant to a fuel cell module when power is supplied to the process reactant delivery control means and stopping the flow of the process reactant when power is cut-off; and, a purging gas delivery control means for delivering a purging gas, over a predetermined duration, to a fuel cell module in response to the power being cut-off.

According to aspects of another embodiment of the invention there is provided a gas-purge system suited for use in combination with a fuel cell power module including: a process reactant delivery control means for permitting a flow of a process reactant to a fuel cell module when power is supplied to the process reactant delivery control means and stopping the flow of the process reactant when power is cut-off; and, a purging gas delivery control means for delivering a predetermined volume of a purging gas, over a predetermined duration, to a fuel cell module after the power is cut-off.

According to aspects of another embodiment of the invention there is provided a method of delivering a purging gas to a fuel cell module under test after power has been cut-off including: stopping process reactant flows to the fuel cell module under test; temporarily opening a purging gas flow to the fuel cell module under test for a predetermined duration; and, stopping the purging gas flow after the predetermined duration.

According to aspects of another embodiment of the invention there is provided a method of operating a fuel cell test station after power has been cut-off comprising: closing fuel and oxidant supply lines thereby ceasing the delivery of fuel and oxidant to a fuel cell module under test; temporarily opening a purging gas flow thereby delivering a predetermined amount of the purging gas to the fuel cell module under test; and, closing the purging gas flow after a predetermined duration.

Other aspects and features of the present invention will become apparent, to those ordinarily skilled in the art, upon review of the following description of the specific embodiments of the invention.

### BRIEF DESCRIPTION OF THE DRAWINGS

For a better understanding of the present invention, and to show more clearly how it may be carried into effect, reference will now be made, by way of example, to the accompanying drawings, which illustrate aspects of embodiments of the present invention and in which:

FIG. 1 is a simplified schematic drawing of a fuel cell test station in combination with a fuel cell module;

FIG. 2 is a schematic drawing of a gas-purge system according to an embodiment of the invention; and

FIG. 3 is a flow chart of a gas-purge method according to an embodiment of the invention.

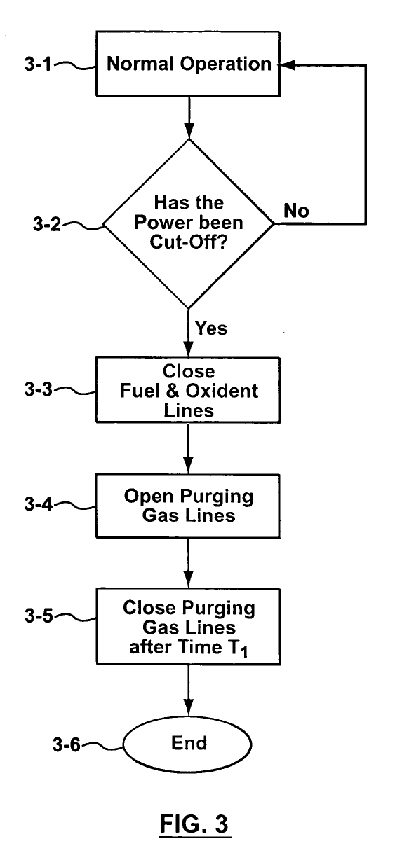

### DETAILED DESCRIPTION OF THE INVENTION

A fuel cell testing trial may either be a fuel cell test condition that is allowed to run in steady state or an automated test sequence that puts the fuel cell through a programmed set of operating conditions. Abruptly cutting off the power to a fuel cell test station during a trial may, in some instances, be necessary to prevent accidents that may damage equipment and/or harm nearby operators/technicians. Yet, abruptly shutting down a trial may leave the fuel cell test station and fuel cell module under test in a potentially hazardous condition as residual amounts of reactive fuel and oxidant may remain in various parts of the system, since they may not have been completely consumed and/or expelled when the power was cut off. It is thus desirable to flush the systems with a purging gas, such as nitrogen, to reduce the possibility of damage caused by residual amounts of fuel and oxidant remaining in the system. However, since the power in such circumstances is cut-off, delivering the purging gas in a reliable way so as to prevent undesired side effects, such as the drying out of the membranes included in some fuel cells, has not previously been achieved. In some embodiments of the invention there is provided a gas-purge system and method, which can be advantageously employed immediately after a loss of power occurs, that controllably delivers a purging gas, such as nitrogen, to a fuel cell test station and fuel cell module under test.

Fuel cells are commonly connected in series to form a fuel cell stack, although in some instances a fuel cell stack may simply include a single fuel cell. The fuel cell stack provides a larger electric potential than a single fuel cell; and, since the fuel cell stack effectively operates as one unit, a co-operative design for supporting systems and instrumentation required by the constituent fuel cells is possible. A fuel cell stack is typically enclosed in a single housing that is designed to include connections for piping, sensors, regulators, and other instrumentation used to support the operation of the fuel cell stack. The fuel cell stack, housing, and associated combination of hardware, software and firmware make up a fuel cell module. Accordingly, it may be desirable to test individual fuel cell stacks or complete fuel cell power modules.

There are a wide variety of different fuel cell technologies that lend themselves to fuel cell stack arrangements. In general, this invention is expected to be applicable to any type of fuel cell, including Proton Exchange Membrane (PEM) fuel cells, alkaline, direct methanol, molten carbonate, phosphoric acid and solid oxide fuel cells.

During a testing process a number of process and operating parameters (such as temperature, internal pressures, electrical outputs, etc.) of a fuel cell module are closely monitored and regulated by a fuel cell test station. Operating parameters of particular interest include a voltage across each fuel cell in a fuel cell stack, commonly referred to as cell voltage, and an internal resistance of each fuel cell. Moreover, the process gases are typically delivered to a fuel cell module at respective flow rates and each also have a corresponding temperature, pressure and relative humidity. Typically, the reaction products and un-reacted process reactants are circulated away from the fuel cell module. However, fuel cells can also be operated in a dead-end mode in which process reactants are supplied to a fuel cell but neither un-reacted process reactants nor reaction products are circulated away from the fuel cell. Commonly, there is also a coolant supplied to the fuel cell stack and it may be desirable to monitor related parameters such as the inlet and outlet temperatures of the coolant and the coolant flow rate. Monitoring and regulating all of these parameters ensures preferable performance of the fuel cell module for a given output demand required by a particular load. Thus, during the testing of a fuel cell module a number of the aforementioned process and operating parameters are varied and outputs are in turn monitored to evaluate the performance of the fuel cell module under different conditions so that the preferable settings for the process and operating parameters can be ascertained for different loading conditions.

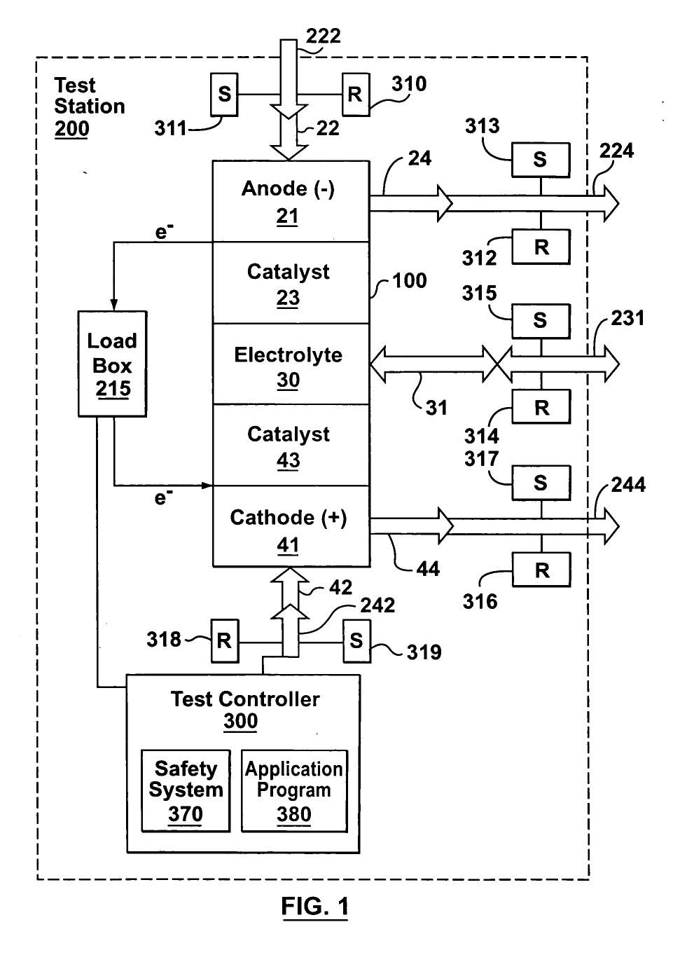

Referring now to FIG. 1, shown is a simplified schematic drawing of a fuel cell test station 200 in combination with a fuel cell module 100 that is described herein to illustrate some general considerations relating to the testing of fuel cell modules. It is to be understood that the present invention is applicable to the testing of various configurations of fuel cell modules that would each include a suitable combination of supporting systems, instrumentation, hardware, software, firmware and structural elements.

The fuel cell module 100 has an anode 21 and a cathode 41. The anode 21 has a gas input port 22 and a gas output port 24. Similarly, the cathode 41 has a gas input port 42 and a gas output port 44. The fuel cell module 100 also includes a water Input/Output (I/O) port 31 through which water can be supplied to and/or removed from the fuel cell module 100. The fuel cell module 100 also includes a first catalyst 23 in close proximity to the anode 21, a second catalyst 43, in close proximity to the cathode 41, and an electrolyte 30 between the anode 21 and the cathode 41. Also shown in FIG. 1 is a loadbox 215 belonging to the fuel cell test station 200, coupled between the anode 21 and the cathode 41.

In operation, hydrogen is introduced into the anode 21 via the gas input port 22 under some predetermined conditions. Examples of the predetermined conditions may include factors such as flow rate, temperature, pressure, relative humidity and a mixture of the hydrogen with other gases. The hydrogen reacts electrochemically according to equation (1) (given below) in the presence of the electrolyte 30 and the first catalyst 23.
H₂→2H⁺+2e⁻ (1)
The products of equation (1) are hydrogen ions and electrons. The hydrogen ions pass through the electrolyte 30 to the cathode 41 while the electrons are drawn through the loadbox 215. Un-reacted hydrogen and other gases are drawn out through gas output port 24.

Simultaneously (to the reactions in the anode 21 described above) an oxidant, such as air, is introduced into the cathode 41 via the gas input port 42 under some predetermined conditions. Examples of the predetermined conditions may again include factors such as flow rate, temperature, pressure, relative humidity and a mixture of the oxidant with other gases. The oxidant reacts electrochemically according to equation (2) (given below) in the presence of the electrolyte 30 and the second catalyst 43.
1/2O₂+2H⁺+2e⁻→H₂O (2)
It can be noted from equation (2), that the electrons and the ionized hydrogen atoms, produced in equation (1) at the anode 21, are consumed in the reaction at the cathode 41. Excess gases, including un-reacted oxidant, and water are drawn out of the cathode 41 through gas output port 44.

With further reference to FIG. 1, the test station 200 includes some basic features found in a practical fuel cell test station. Those skilled in the art will appreciate that a practical test station includes a suitable combination of sensors, regulators, control lines, supporting apparatus/instrumentation and structural elements in addition to a suitable combination of hardware, software and firmware. Furthermore, it is also to be understood that the description provided herein, relating to the simplified test station 200, is by no means meant to restrict the scope of the claims following this section.

The test station 200 includes a test controller 300 that is used to manage fuel cell testing by a skilled operator. In some embodiments the test controller 300 is made up of a single server or computer having at least one microcomputer; and, in other embodiments the test controller 300 is made up of a combination of microcomputers appropriately configured to divide the tasks associated with fuel cell testing amongst the combination of microcomputers.

In some embodiments the test controller 300 is made up of a computer usable medium having a computer program readable code means, having instructions for a safety system 370 and at least one application program 380. In the present embodiment of the invention the test controller 300 includes a memory device (not shown) storing a computer program readable code means having instructions for the safety system 370 and the at least one application program 380. The at least one application program 380 contains user designed test vectors for varying the process and operating parameters of a fuel cell module under test. In some embodiments, application programs are made up of computer program readable code means having data and instructions for executing a sequence of test vectors defining a specific testing scenario.

The test station 200 also includes a number of physical connections to ports of the fuel cell module 100 that are used to supply process gases and vent exhaust and un-used process gases from the fuel cell module 100. The physical connections include gas supply ports 222 and 242, gas exhaust ports 224 and 244 and a water supply exchange port 231. The gas supply ports 222 and 242 are coupled to the gas input ports 22 and 42 of the fuel cell module 100, respectively. The gas exhaust ports 224 and 244 are coupled to the gas output ports 24 and 44 of the fuel cell module 100, respectively. The water supply exchange port 231 is coupled to the water I/O port 31 of the fuel cell module 100.

Additionally, there are a number of sensor connections between the test station 200 and the fuel cell module 100. The sensor connections are advantageously used to monitor reaction products and electrical outputs produced by the fuel cell module 100, as well as other process and operating parameters. In the present embodiment, the testing system 200 includes sensors 311, 313, 315, 317 and 319 that are connected to the ports 222, 224, 231, 244 and 242, respectively. The sensors 311, 313, 315, 317 and 319 may be used, for example, to monitor one or more of the temperature, pressure, composition and relative humidity of input and output gases or fluid flows through any of the ports 222, 224, 231, 244 and 242.

The test controller 300 is also electrically connected to the regulators 310, 312, 314, 316 and 318 that are used to regulate process and operating parameters associated with the ports 222, 224, 231, 244 and 242, respectively.

Moreover, as noted above, the test station 200 includes the loadbox 215 that is connectable to the anode 21 and cathode 41 electrodes of the fuel cell module 100. The voltage across and the current drawn by the loadbox 215 is controllable so that different loading conditions can be imposed upon the fuel cell module 100 during testing.

In operation the test controller 300 executes test vectors provided in the at least one application program 380. This is done by extracting the test vectors from the at least one application program 380 and, in turn, varying the loading conditions provided by the loadbox 215 and/or other process and operating parameters in accordance with the test vectors provided. The latter is accomplished by having the test controller 300 transmit control signals to the regulators 310, 312, 314, 316 and 318. The test controller 300 then receives measurements related to the reaction products, electrical outputs and/or other process and operating parameters from the sensors 311, 313, 315, 317 and 319. The measurements can be recorded and evaluated.

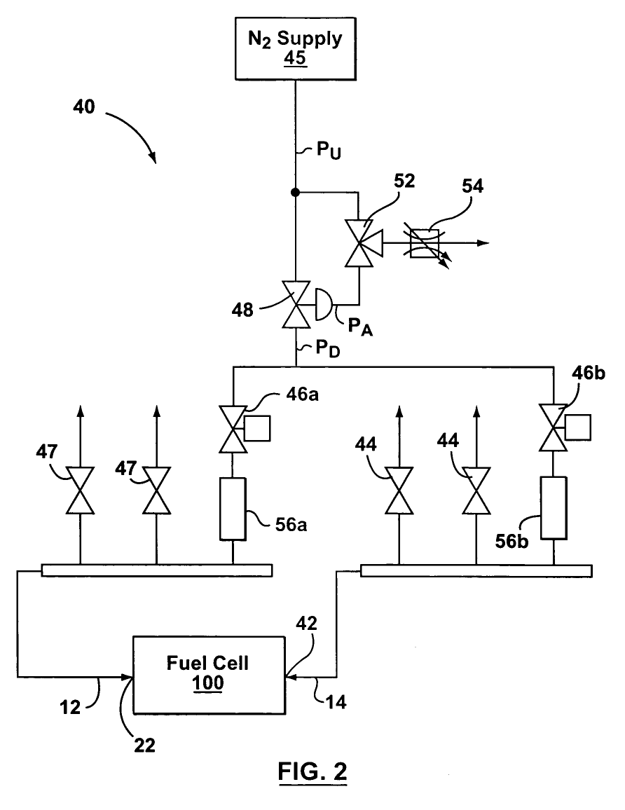

Referring now to FIG. 2, illustrated is a schematic drawing of a gas-purge system 40 according to an embodiment of the invention that may be provided in combination with and/or within a fuel cell test station. Only those features necessary to describe aspects of the gas-purge system 40 as they relate to an embodiment of the invention have been illustrated. Those skilled in the art will appreciate that a fuel cell test station will include a suitable combination of sensors, regulators, control lines, supporting apparatus/instrumentation, structural elements and a suitable sub-combination of hardware, software and firmware in addition to the features illustrated in FIG. 2.

The gas-purge system 40 is arranged to provide a predetermined amount of a purging gas, such as nitrogen, over a known and fixed duration, to a fuel cell module 100 under test with a fuel cell test station when the power supplied to the fuel cell test station is abruptly cut-off. That is, when the power is cut-off, fuel and oxidant lines 12 and 14 are flushed with the purging gas, as is the fuel cell module 100. To this end, the gas-purge system 40 includes a combination of valves arranged between a nitrogen supply 45 (i.e. the purging gas source) and the fuel cell 100, as illustrated in FIG. 2.

Similar to FIG. 1, the fuel cell module 100 in FIG. 2 is provided with gas input ports 22 and 42 that are in fluid connection with the anode and the cathode side of the fuel cell module 100, respectively. The gas input ports 22 and 42 are connectable to fuel and oxidant supply lines 12 and 14, respectively. The fuel and oxidant supply lines 12 and 14 are respectively connected to corresponding fuel and oxidant supplies (not shown) through at least one shut-off valve. Specifically, the fuel supply line 12 is connected to the fuel supply through at least one fuel shutoff valve 47 that is preferably a normally closed valve. Similarly, the oxidant supply line 14 is connected to the oxidant supply through at least one oxidant shutoff valve 44 that is also preferably a normally closed valve.

The fuel and oxidant supply lines 12 and 14 are also both connected to the nitrogen supply 45 through a combination of valves and metering devices that are placed in parallel to the fuel and oxidant shutoff valves 47 and 44. Specifically, the fuel supply line 12 is also coupled to a first rotameter 56a that is connected in series to a first nitrogen shutoff valve 46a that leads to the nitrogen supply 45. Similarly, the oxidant supply line 14 is also coupled to a second rotameter 56b that is connected in series to a second nitrogen shutoff valve 46b that leads to the nitrogen supply 45. Preferably both the nitrogen shutoff valves 46a, 46b are normally open valves.

A normally closed valve is opened, thus permitting a free flow of gases (or liquids), only when a control signal (or some electromotive force) is continuously supplied to the valve. That is, when power is not supplied to a normally closed valve, the valve remains closed, thus preventing the free flow of gases (or liquids) through the valve. By contrast, a normally open valve is closed, thus stopping the free flow of gases (or liquids), only when a control signal (or some electromotive force) is continuously supplied to the valve. That is, when power is not supplied to a normally open valve, the valve remains open, thus allowing the free flow of gases (or liquids) through the valve.

Both the first and second nitrogen shutoff valves 46a and 46b are connected to the nitrogen supply 45 through a dome loaded pressure valve 48 that is arranged between the nitrogen supply 45 and the first and second nitrogen shutoff valves 46a and 46b. The dome loaded pressure valve 48 includes an internal diaphragm that has to be sufficiently loaded to permit the flow of nitrogen through the valve 48. In order to provide the required pressure to the diaphragm of the dome loaded pressure valve 48 a 3/2-way solenoid valve 52 is connected upstream of the dome loaded pressure valve 48 and to the diaphragm of the dome loaded pressure valve 48. The 3/2-way solenoid valve 52 is employed as a pressure relay and permits the diaphragm to be loaded with nitrogen pressure (P_{U}) from immediately upstream of the dome loaded pressure valve 48. That is, the pressure P_{U} of the nitrogen immediately upstream of the dome loaded pressure valve 48 (e.g. the pressure of the nitrogen exiting the nitrogen supply 45) is translated to the diaphragm of the dome loaded pressure valve 48 through the 3/2-way solenoid valve 52, during powered operation, which is described in further detail below. The 3/2-way solenoid valve 52 also has a vent port to which an adjustable needle valve 54 is coupled. Those skilled in the art will appreciate that a solenoid valve is typically an active device requiring power to remain open, whereas a needle valve is typically a passive device that does not require power for its operation.

In operation the gas-purge system 40 is in one of two states. In a first state, power is supplied to various constituent systems of the fuel cell test station, including the gas-purge system 40. In a second state, the power supplied to the fuel cell test station has been cut-off, which means that the power supplied to the various constituent systems, including the gas-purge system 40, has been cut-off.

In the first state power is provided to the gas-purge system 40 and is coupled to the active devices, which include the normally closed fuel and oxidant shutoff valves 47 and 44, respectively, the normally open nitrogen shutoff valves 46a, 46b and the 3/2-way solenoid valve 52. Since the nitrogen shutoff valves 46a, 46b are normally open valves the power supplied to them closes them. The result is that the nitrogen supply 45 is cut-off from the fuel and oxidant supply lines 12 and 14. The opposite occurs in the normally closed fuel and oxidant shutoff valves 47 and 44, which are open in the first state, connecting the fuel and oxidant supplies (not shown) to the fuel and oxidant supply lines 12 and 14, respectively. Thus, in the first state of operation the gas-purge system 40 permits the free flow of fuel and oxidant into the fuel and oxidant supply lines 12 and 14, respectively, leading to the fuel cell module 100, and simultaneously stops the flow of nitrogen into the fuel and oxidant supply lines 12 and 14.

Also, despite being effectively cut-off from the fuel and oxidant lines 12 and 14, the 3/2-way solenoid valve 52 is also supplied with power in the first state. The power supplied opens the 3/2-way solenoid valve 52 permitting nitrogen to flow through it causing the pressure applied (P_{A}) to the diaphragm of the dome loaded pressure valve 48 to be the same as the pressure P_{U} immediately upstream of the dome loaded pressure valve 48, thus opening the dome loaded pressure valve 48 during normal operation.

In the second state, power supplied to the gas-purge system 40 is abruptly cut-off, as it is to the rest of the fuel cell test station. The immediate consequences of this are that the normally closed fuel and oxidant shutoff valves 47 and 44 close; and, the normally open nitrogen shutoff valves 46a, 46b open. That is, the fuel and oxidant flows to the fuel cell 100 are stopped and the nitrogen flow path is temporarily opened. The 3/2-way solenoid valve 52 also closes, cutting off the flow path from the nitrogen supply 45 to the diaphragm of the dome loaded pressure valve 48, and trapping some nitrogen between the 3/2-way solenoid valve 52 and the diaphragm of the dome loaded pressure valve 48. Just after the 3/2-way solenoid valve 52 closes, immediately after the loss of power, the applied pressure P_{A} on the diaphragm is about the same as the nitrogen pressure P_{U}, since the trapped nitrogen is still at approximately the same pressure as it was just before the power was abruptly lost.

However, the nitrogen trapped between the now closed 3/2-way solenoid valve 52 and the diaphragm of the dome loaded pressure valve 48 is able to slowly bleed out through the needle valve 54 connected to the venting port of the 3/2-way solenoid valve 52. As the trapped nitrogen bleeds out through the needle valve 54 the applied pressure P_{A} on the diaphragm slowly decays, which, in turn, slowly closes the dome loaded pressure valve 48, again cutting off the nitrogen supply 45 from the fuel and oxidant supply lines 12 and 14. As long as a sufficient amount of gas pressure remains on the diaphragm, the dome loaded pressure valve 48 remains open, in turn permitting nitrogen flow to the fuel cell stack 100. As the trapped nitrogen vents out through the needle valve 54, the pressure on the diaphragm decays, slowly closing the dome loaded pressure valve 48 until it is substantially completely closed.

In the second state, the duration of time T₁ it takes to close the dome loaded pressure valve 48 is adjustable by adjustment to the needle valve 54. Adjustments to the needle valve 54 change the rate at which the trapped purging-gas (e.g. nitrogen) leaves the space between the 3/2-way solenoid valve 52 and the diaphragm of the dome loaded pressure valve 48, which in turn changes the amount of time T₁ it takes to close the dome loaded pressure valve 48. Without the timed operation provided by the needle valve 54 the purging gas would be supplied until the purging gas supply (e.g. the nitrogen supply 45) is empty, which could dry out the membranes of a fuel cell module, and could exhaust the supply of the purging gas, each time a fuel station is abruptly stopped. The flow rate of nitrogen to the stack may not be steady during the entire purge time (e.g. T₁) due to the decaying pressure, but rotameters 56a, 56b may be provided to meter the nitrogen flow rate independently of the duration of the purge.

Referring now to FIG. 5, illustrated is a flow chart depicting the general steps provided in a gas-purge method according to an embodiment of the invention. The method begins at step 3-1, in which a fuel cell test station is operating normally. That is, the fuel cell test station is drawing power to function. At step 3-2 of the gas-purge method, it is determined whether or not the power to the fuel cell test station has been cut-off. If the power has not been cut-off (no path, step 3-2) the method loops back to step 3-1. On the other hand if the power has been cut-off (yes path, step 3-2) the gas-purge method proceeds to step 3-3 in which the fuel and oxidant lines leading to a fuel cell are immediately closed.

After step 3-3, a purging-gas line is temporally opened at step 3-4. Opening the purging-gas line flushes gas lines of the fuel cell test station and the fuel cell module under test with a purging-gas, such as nitrogen. Subsequently, at step 3-5, after a predetermined duration of T₁, the purging-gas line is closed. Closing the purging-gas lines after this set duration T₁ reduces the possibility that too much of the purging-gas is delivered. Accordingly, the possibility of membranes, included in some fuel cells under test, drying out is also reduced as a result of this controlled delivery of the purging gas.

A gas-purge system and method according to an embodiment of the invention provides a means for controlling the shutdown operation of a fuel cell test station even after power is lost, such as in an emergency stop situation. Such a gas-purge system and method substantially flushes all hydrogen and oxidant out of the gas supply and exhaust lines, vessels and the fuel cell module under test.

While the above description provides example embodiments, it will be appreciated that the present invention is susceptible to modification and change without departing from the fair meaning and scope of the accompanying claims. Accordingly, what has been described is merely illustrative of the application of aspects of embodiments of the invention. Numerous modifications and variations of the present invention are possible in light of the above teachings. It is therefore to be understood that within the scope of the appended claims, the invention may be practiced otherwise than as specifically described herein.

We claim:

1. A gas-purge system suited for use in combination with a fuel cell power module comprising:
a process reactant delivery control means for permitting a flow of a process reactant to a fuel cell module when power is supplied to the process reactant delivery control means and stopping the flow of the process reactant when power is cut-off; and
a purging gas delivery control means for delivering a predetermined volume of a purging gas to a fuel cell module in response to the power being cut-off.

2. A gas-purge system according to claim 1, wherein the process reactant delivery control means includes a normally closed valve connectable between the fuel cell module under test and a process reactant supply.

3. A gas-purge system according to claim 2, wherein the process reactant delivery control means controls the delivery of at least one of hydrogen and an oxidant.

4. A gas-purge system according to claim 1, wherein the purging gas delivery means comprises:
a first pressure-controlled gate, having a control point, that is operable to open when a suitable pressure is applied to the control point and otherwise to close, and the first pressure-controlled gate is connectable between a purging-gas supply and the fuel cell module under test;
a pressure relay connectable between the purging-gas supply and the control point of the first pressure-controlled gate, operable to transfer gas pressure from the purging gas supply to the control point when power is supplied, and subsequently, cut-off the purging gas supply from the control point when the power is cut-off and permit a controlled release of pressure from the control point thereby gradually closing the first pressure-controlled gate after the power is cut-off; and
a normally open valve connectable between the first pressure-controlled gate and the fuel cell module under test.

5. A gas-purge system according to claim 4, wherein the first pressure-controlled gate is a dome loaded pressure valve having a diaphragm serving as the control point.

6. A gas-purge system according to claim 4, wherein the pressure relay comprises a 3/2-way solenoid valve, having a venting port, which is operable to open a flow path between the purging gas supply and the control point of the first pressure-controlled gate when power is supplied and cut-off the purging gas supply from the control point when the power is cut-off.

7. A gas-purge system according to claim 4, wherein the pressure relay further comprises an adjustable needle valve connectable to the venting port of the 3/2-way solenoid valve for controlling the rate at which pressure is controllably released from the control point.

8. A gas-purge system for controllably delivering a purging gas to a fuel cell module and flushing supply and exhaust lines with the purging gas after power to the gas-system has been cut-off, the gas-purge system comprising:
a normally closed valve connectable between at least one process reactant supply and the fuel cell module;
a normally open valves connected between at least one purging-gas supply and the fuel cell module;
a first pressure-controlled gate, having a control point, that is operable to open when a suitable pressure is applied to the control point and otherwise to close, and the first pressure-controlled gate is connectable between the at least one purging-gas supply and the fuel cell module; and
a pressure relay connectable between the at least one purging-gas supply and the control point of the first pressure-controlled gate, operable to transfer gas pressure from the purging gas supply to the control point when power is supplied, and subsequently, cut-off the purging gas supply from the control point when the power is cut-off and permit a controlled release of pressure from the control point thereby gradually closing the first pressure-controlled gate after the power is cut-off.

9. A gas-purge system according to claim 8, wherein the first pressure-controlled gate is a dome loaded pressure valve having a diaphragm serving as the control point.

10. A gas-purge system according to claim 8, wherein the pressure relay comprises a 3/2-way solenoid valve, having a venting port, which is operable to open a flow path between the at least one purging gas supply and the control point of the first pressure-controlled gate when power is supplied and cut-off the at least one purging gas supply from the control point when the power is cut-off.

11. A gas-purge system according to claim 8, wherein the pressure relay further comprises an adjustable needle valve connectable to the venting port of the 3/2-way solenoid valve for controlling the rate at which pressure is controllably released from the control point.

12. A gas-purge system suited for use in combination with a fuel cell power module comprising:
a process reactant delivery control means for permitting a flow of a process reactant to a fuel cell module when power is supplied to the process reactant delivery control means and stopping the flow of the process reactant when power is cut-off; and
a purging gas delivery control means for delivering a purging gas, over a predetermined duration, to a fuel cell module in response to the power being cut-off.

13. A gas-purge system according to claim 12, wherein the process reactant delivery control means includes a normally closed valve connectable between the fuel cell module under test and a process reactant supply.

14. A gas-purge system according to claim 13, wherein the process reactant delivery control means controls the delivery of at least one of hydrogen and an oxidant.

15. A gas-purge system according to claim 12, wherein the purging gas delivery means comprises:
a first pressure-controlled gate, having a control point, that is operable to open when a suitable pressure is applied to the control point and otherwise to close, and the first pressure-controlled gate is connectable between a purging-gas supply and the fuel cell module under test;
a pressure relay connectable between the purging-gas supply and the control point of the first pressure-controlled gate, operable to transfer gas pressure from the purging gas supply to the control point when power is supplied, and subsequently, cut-off the purging gas supply from the control point when the power is cut-off and permit a controlled release of pressure from the control point thereby gradually closing the first pressure-controlled gate after the power is cut-off; and
a normally open valve connectable between the first pressure-controlled gate and the fuel cell module under test.

16. A gas-purge system suited for use in combination with a fuel cell power module comprising:
a process reactant delivery control means for permitting a flow of a process reactant to a fuel cell module when power is supplied to the process reactant delivery control means and stopping the flow of the process reactant when power is cut-off; and
a purging gas delivery control means for delivering a predetermined volume of a purging gas, over a predetermined duration, to a fuel cell module after the power is cut-off.

17. A method of delivering a purging gas to a fuel cell module under test after power has been cut-off comprising:
stopping process reactant flows to the fuel cell module under test;
temporarily opening a purging gas flow to the fuel cell module under test for a predetermined duration; and
stopping the purging gas flow after the predetermined duration.

18. A method of operating a fuel cell test station after power has been cut-off comprising:
closing fuel and oxidant supply lines thereby ceasing the delivery of fuel and oxidant to a fuel cell module under test;
temporarily opening a purging gas flow thereby delivering a predetermined amount of the purging gas to the fuel cell module under test; and
closing the purging gas flow after a predetermined duration.
